(19) United States
(12) Patent Application Publication
(10) Pub. No.: US 2023/0301864 A1
(43) Pub. Date: Sep. 28, 2023

(54) TECHNOLOGIES FOR IMPROVING THE GAIT OF INDIVIDUALS WITH PARKINSON'S DISEASE

(71) Applicant: David Barwick, Warana (AU)

(72) Inventor: David Barwick, Warana (AU)

(21) Appl. No.: 17/700,614

(22) Filed: Mar. 22, 2022

(51) Int. Cl. A61H 3/00

(52) U.S. Cl. CPC A61H 3/00; A61H 2201/1652; A61H 2003/007; A61H 2230/625; A61H 2201/5007; A61H 2201/1215

(57) ABSTRACT

Technology for assisting individuals with Parkinson's disease is disclosed. In the illustrative embodiment, an individual with Parkinson's disease can wear a device that applies a time-varying force to the patient. For example, in one embodiment, an individual wears a backpack with a weighted component that can be moved around. The change in position and/or orientation of the weighted component requires the user to actively compensate in order to stay balanced. The additional effort required to walk can improve the gait of individuals with Parkinson's disease.

### BACKGROUND

Parkinson's disease is a degenerative disorder of the central nervous system. Individuals with Parkinson's disease often have difficulty with motor skills. Individuals with Parkinson's may have a shuffling gait with a stooped-over posture, making movement difficult. However, certain motor skill activities can bypass the damaged part of the brain, allowing a person with Parkinson's disease to perform more complex tasks such as biking. Increasing the complexity of the task of walking can improve gait as well, such as by asking a person with Parkinson's to bounce a ball as they walk.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a person walking with a device that imparts time-varying forces to the user by moving a weighted component.

FIG. 2 illustrates the device of FIG. 1 with the weighted component in a leftward configuration.

FIG. 3 illustrates the device of FIG. 1 with the weighted component in a rightward configuration.

FIG. 4 illustrates the device of FIG. 1 with the weighted component in a straight back configuration.

FIG. 5 illustrates the device of FIG. 1 with the weighted component in an upward configuration.

FIG. 6 illustrates an alternative embodiment of the device of FIG. 1 with a weighted component that can move linearly.

FIG. 7 illustrates the device of FIG. 6 with the weighted component in a different position.

FIG. 8 is a simplified block diagram of at least one embodiment of a computing device of the device of FIG. 1.

FIG. 9 is a simplified block diagram of at least one embodiment of an environment that may be established by the computing device of FIG. 8.

FIG. 10 is a simplified flow diagram of at least one embodiment of a method for improving a gait of a user by moving the weighted component of the device of FIG. 1 that may be executed by the computing device of FIG. 8.

FIG. 11 is a simplified flow diagram of at least one embodiment of a method for treating a patient with Parkinson's using the device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

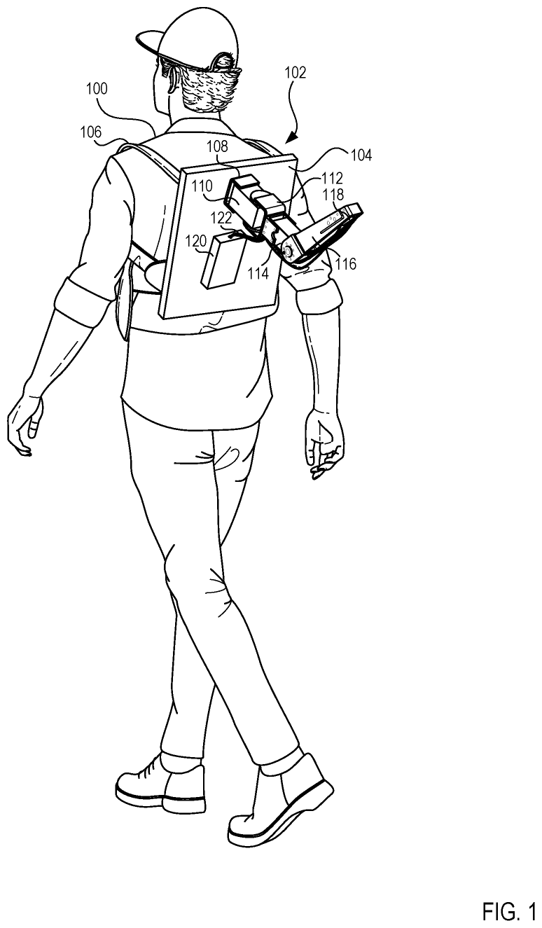

Referring now to FIG. 1, in the illustrative embodiment, a user 100 with Parkinson's disease carries a device 102 on his back. A weighted component 116 of the device 102 moves in a time-varying manner, shifting the balance of the user 100 enough to complicate the task of walking, which can dramatically improve the gait and posture of the user 100. In one test, an individual with Parkinson's disease was able to walk with a normal gait and an erect posture when the device was activated.

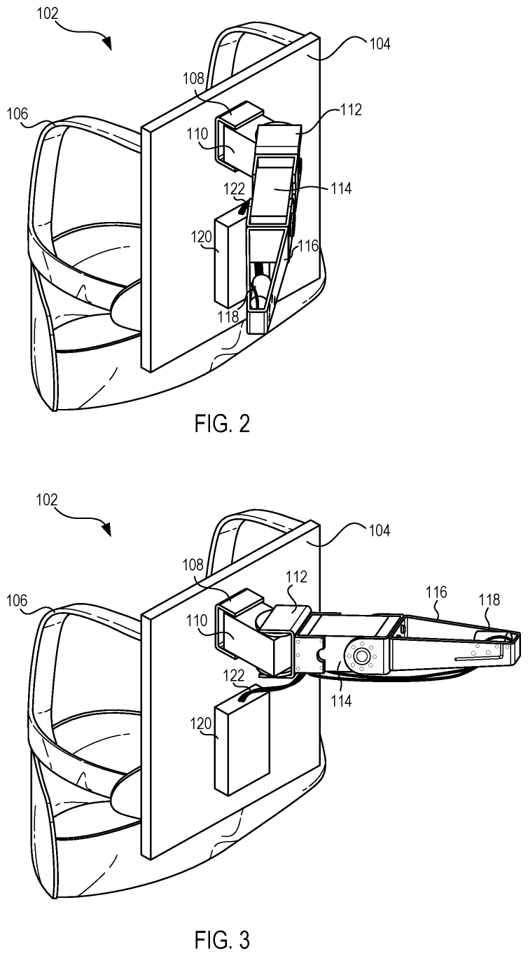

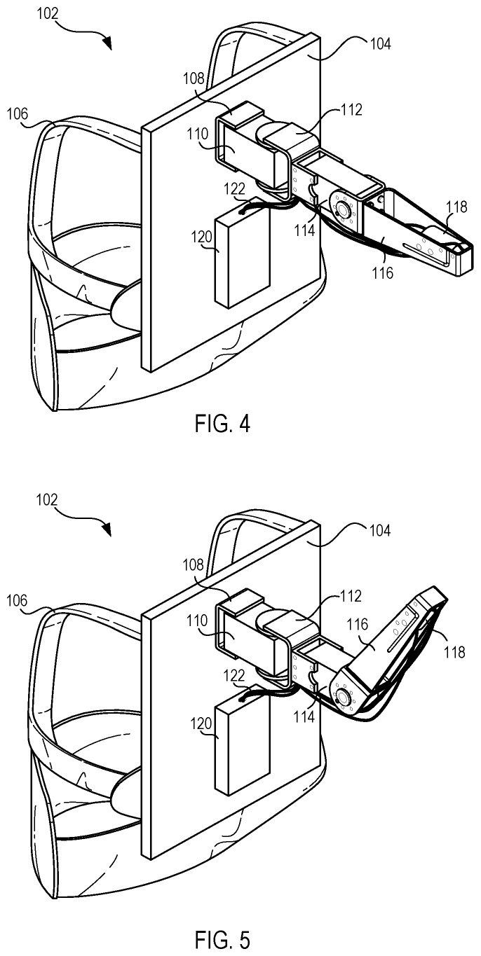

The device 102 has a plate 104, to which straps 106 are attached. The straps 106 allow the user 100 to wear the device 102 like a backpack. A first bracket 108 is attached to the plate 104 and to a first motor 110. A second bracket 112 is attached to the first motor 110. The second bracket 112 is also attached to a second motor 114. A weighted component 116 is attached to the second motor. In the illustrative embodiment, the motor 110 can rotate the bracket 112 (and motor 114 and weighted component 116) in a horizontal plane, as shown in FIGS. 2 and 3. The motor 114 can rotate the weighted component 116 in a vertical plane, as shown in FIGS. 4 and 5.

In the illustrative embodiment, a battery 118 is mounted in the weighted component 116 and forms part or all of the weight in the weighted component 116. The battery 118 is connected to a controller 120 mounted on the plate 104 with one or more wires 122. One or more wires 122 also connect the controller and/or battery 118 to each motor 110, 114.

In use, a user 100 puts on the device 102 like a backpack, as shown in FIG. 1. In some embodiments, the user 100 may adjust the length of the straps 106 and/or may buckle one or more buckles to secure the device 102 in place. When the device 102 is activated, the controller 120 drives the motor 110 and/or the motor 114 to shift the position of the weighted component 116. Both the force on the user 100 as the weighted component 116 is moving and the change in center of mass of the device 102 require the user 100 to compensate in order to walk. As discussed in more detail below, in the illustrative embodiment, the controller 120 moves the weighted component 116 in a manner that is random or otherwise unpredictable or irregular. In the illustrative embodiment, the compensations that the user 100 must make can allow a user with Parkinson's disease to walk with an improved gait.

The plate 104 may be any suitable material, such as metal, wood, plastic, or other rigid material. In the illustrative embodiment, the plate 104 is rigid in order to transfer the force from the shift in the weighted component 116 to the user 100 more uniformly and comfortably. In other embodiments, the plate 104 or other mounting surface may not be rigid.

The straps 106 may be arranged in any suitable configuration. In the illustrative embodiment, there are two shoulder straps that go over the user's shoulders and one or more straps across the front of the user, such as a chest strap and/or waist strap. In other embodiments, the straps 106 may have a different configuration, such as a single should strap, only chest or waist straps, etc. In the illustrative embodiment, the straps 106 hold the device 102 in place with the weighted component 116 on the back of the user 100. In other embodiments, the weighted component may be in a different position, such as in front of the user 100 or on the side of the user 100. The straps 106 may be made of any suitable material, such as nylon, cotton, polyester, plastic, etc.

Each of the brackets 108, 112 may be made of any suitable material, such as metal or plastic. The brackets 108, 112 may be secured to the plate, first motor 110, and/or second motor 114 in any suitable manner, such as using bolts, screws, or other fasteners, glue or other adhesive, etc. Each of the motors 110, 114 may be any suitable motor, such as a brushed motor, a brushless motor, a direct drive motor, a linear motor, a rotary motor, a stepper motor, a servo motor, etc. Each of the motors 110, 114 is capable of moving the weighted component 116 at a rate of, e.g., 10-180° per second.

In the illustrative embodiment, the weighted component 116 extends a length outward from the second motor 114, allowing the second motor 114 to reposition the weighted component 116 by rotating it. The weighted component 116 may extend from the second motor 114 any suitable amount, such as 1.5-20 centimeters. The weighted component 116 may extend from the first motor 110 a greater amount, depending on the length of the second motor 114, such as 5-30 centimeters. The mass of the weighted component 116 may be any suitable mass, such as 100-2,000 grams. The weighted component 116 may have a separate mass that can attach to a bracket, or the mass of the weighted component 116 may come from its intrinsic mass. In the illustrative embodiment, the battery 118 is disposed at a distal end of the weighted component 116 relative to the motor 114. In the illustrative embodiment, the device 102 changes the position and/or orientation of one weighted component 116. In other embodiments, the device 102 may change the position and/or orientation of more than one weighted component 116.

The force and/or torque experienced by the user 100 depends on the linear and/or rotational acceleration and/or movement of the motors 110, 114 and weighted component 116, as well as the position and orientation of the motors 110, 114 and the weighted component. Depending on the configuration, the user 100 may experience a change in force of, e.g., 1-20 Newtons and/or a change in torque of 0.1-3 Newton-meters in any suitable direction as a result of the acceleration and/or change in position or orientation. The change in force and/or torque may happen in, e.g., 0.1-3 seconds.

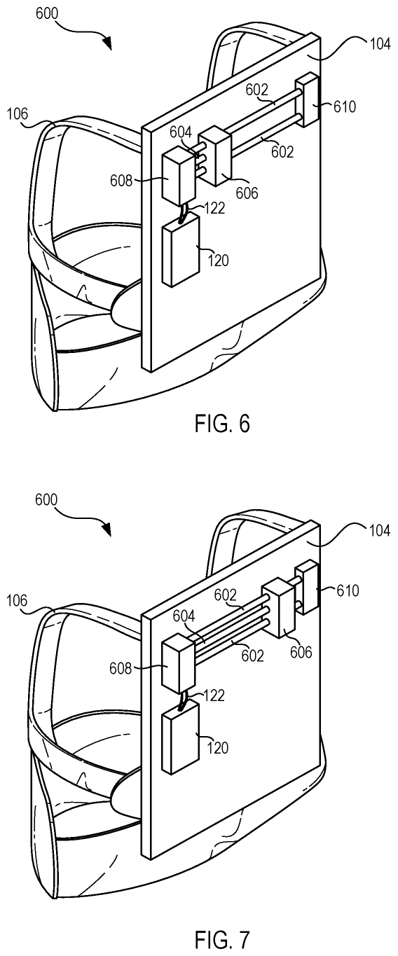

In the illustrative embodiment, the weighted component 116 is mounted on a two-axis arm made up of the motors 110, 114 and brackets 108, 112. In other embodiments, the weighted component 116 may be mounted on a single-axis arm and/or may be connected to a linear actuator, as described below in more detail in regard to FIGS. 6 and 7.

The illustrative battery 118 may have any suitable size, mass, or form factor. The battery 118 may have a 10-200 Watt hours. The battery 118 may have a mass of, e.g., 50-1,000 grams.

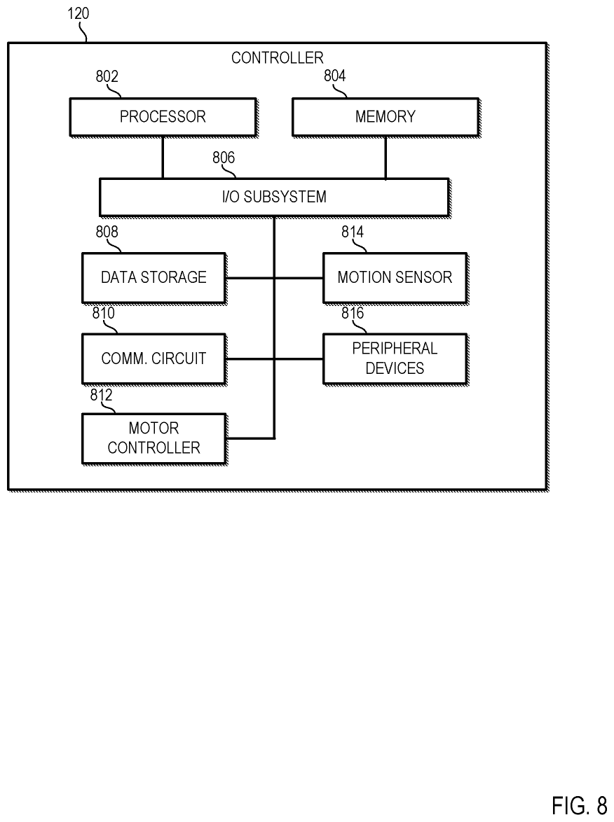

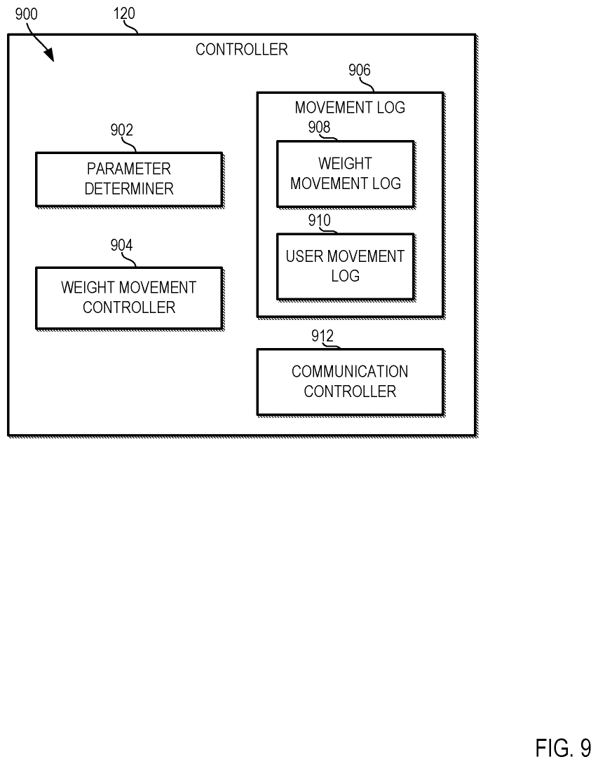

The controller 120 may be mounted to the plate 104 in any suitable manner, such as screwed, bolted, or otherwise fastened to the plate 104. The controller 120 is described in more detail below in regard to FIGS. 8 and 9. The wires 122 connecting the battery 118, controller 120, and/or motors 110, 114 may be any suitable type of wire, such as copper wire. In some embodiments, the wires may be embodied as traces on a circuit board connecting, e.g., the battery 118, controller 120, and/or motors 110, 114.

It should be appreciated that the configuration shown in FIGS. 1-5 is merely one possible embodiment, and other embodiments are envisioned as well. For example, in one embodiment, a device 600 may be configured as shown in FIGS. 6 and 7. Similar components such as the plate 104, controller 120, etc., may be similar or identical in the device 600 as the device 102, a description of which is not repeated in the interest of clarity. In the device 600, one or more rails may support a weighted component 606, which may be a similar mass as the weighted component 116. An actuator 608 may drive a piston 604 to move the weighted component 606 along the rails 602. The actuator 608 may move the weighted component at any suitable speed or acceleration, such as 1-30 centimeters per second. A bracket 610 opposite the actuator 608 can hold the rails in place.

The rails 602 may be any suitable material, such as aluminum, steel, plastic, etc. The actuator 608 may be any suitable motor that can move the piston 604 or otherwise move the weighted component 606. The actuator 608 may be similar to the motors 110, 114 discussed above. The weighted component 606 may be similar to the weighted component 116.

It should be appreciated that the configuration shown in FIGS. 6 and 7 allows for similar forces and torques to be applied to the user 100 as the motor 110 that moves the weighted component 116 in a horizontal plane. A second set of rails may be used to move the weighted component 606 or a separate weighted component in a vertical plane. The configuration in FIGS. 6 and 7 may have a lower profile than the configuration shown in FIGS. 1-5. A cover that mates with the plate 104 may be placed over the various components of the devices 102, 600 to protect and/or hide the components inside.

The alternative embodiment shown in FIGS. 6 and 7 is merely one possible embodiment. Other embodiments may translate and/or rotate one or more weighted components in one or more dimensions using any suitable configuration, such as rails, chains, brackets, gears, etc. In some embodiments, the assembly of the actuator and weighted component may be manually moved before being activated. For example, the weighted component and its mount may be moved more superior (i.e., towards the user's head) or more inferior (i.e., towards the user's feet) on the plate 104 depending on a height or other parameters of the user 100.

Referring now to FIG. 8, in one embodiment, a controller 120 of the devices 102, 600 is shown. The controller 120 determines which movements the weighted components 116, 606 should make and then controls the motors 110, 114 or actuators 608 to move the weighed components 116, 606 accordingly.

The controller 120 may be embodied as any type of computing device. For example, the controller 120 may be embodied as or otherwise include or be included in, without limitation, an embedded computing system, a System-on-a-Chip (SoC), a wearable computer, a multiprocessor system, a processor-based system, a consumer electronic device, a smartphone, a cellular phone, a desktop computer, a server computer, a tablet computer, a notebook computer, a laptop computer, a network device, a router, a switch, a networked computer, a handset, a messaging device, a camera device, and/or any other computing device.

The illustrative controller 120 includes a processor 802, a memory 804, an input/output (I/O) subsystem 806, data storage 808, a communication circuit 810, a motor controller 812, a motion sensor 814, and one or more peripheral devices 816. In some embodiments, one or more of the illustrative components of the controller 120 may be incorporated in, or otherwise form a portion of, another component. For example, the memory 804, or portions thereof, may be incorporated in the processor 802 in some embodiments. In some embodiments, one or more of the illustrative components may be physically separated from another component.

The processor 802 may be embodied as any type of processor capable of performing the functions described herein. For example, the processor 802 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 804 may be embodied as any type of volatile or non-volatile memory or data storage capable of performing the functions described herein. In operation, the memory 804 may store various data and software used during operation of the controller 120 such as operating systems, applications, programs, libraries, and drivers. The memory 804 is communicatively coupled to the processor 802 via the I/O subsystem 806, which may be embodied as circuitry and/or components to facilitate input/output operations with the processor 802, the memory 804, and other components of the controller 120. For example, the I/O subsystem 806 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 806 may connect various internal and external components of the controller 120 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 806 may form a portion of a system-on-a-chip (SoC) and be incorporated, along with the processor 802, the memory 804, and other components of the controller 120 on a single integrated circuit chip.

The data storage 808 may be embodied as any type of device or devices configured for the short-term or long-term storage of data. For example, the data storage 808 may include any one or more memory devices and circuits, memory cards, hard disk drives, solid-state drives, or other data storage devices.

The communication circuit 810 may be embodied as any type of interface capable of interfacing the controller 120 with other computing devices, such as over one or more wired or wireless connections. In some embodiments, the communication circuit 810 may be capable of interfacing with any appropriate cable type, such as an electrical cable or an optical cable. The communication circuit 810 may be configured to use any one or more communication technology and associated protocols (e.g., Ethernet, Bluetooth®, WiMAX, near field communication (NFC), etc.). The communication circuit 810 may be located on silicon separate from the processor 802, or the communication circuit 810 may be included in a multi-chip package with the processor 802, or even on the same die as the processor 802. The communication circuit 810 may be embodied as one or more add-in-boards, daughtercards, network interface cards, controller chips, chipsets, specialized components such as a field programmable gate array (FPGA) or application specific integrated circuit (ASIC), or other devices that may be used by the computing device 802 to connect with another computing device. In some embodiments, communication circuit 810 may be embodied as part of a system-on-a-chip (SoC) that includes one or more processors, or included on a multichip package that also contains one or more processors. In some embodiments, the communication circuit 810 may include a local processor (not shown) and/or a local memory (not shown) that are both local to the communication circuit 810. In such embodiments, the local processor of the communication circuit 810 may be capable of performing one or more of the functions of the processor 802 described herein. Additionally or alternatively, in such embodiments, the local memory of the communication circuit 810 may be integrated into one or more components of the computing device 802 at the board level, socket level, chip level, and/or other levels.

The motor controller 812 is configured to drive the motors 110, 114 and/or actuators 608. The motor controller 812 can provide appropriate voltage and/or current to the motors 110, 114 and/or actuators 608 to drive them at a desired velocity and acceleration.

The motion sensor 814 is configured to sense motion of the user. The motion sensor 814 may be embodied as, e.g., one or more accelerometers, gyroscopes, and/or the like. The motion sensor 814 may be used to sense a gait of the user of the device 102, 600.

In some embodiments, the controller 120 may include other or additional components, such as those commonly found in a computing device. For example, the controller 120 may also have peripheral devices 816, such as a user input (e.g., one or more buttons, keys, touch sensors, etc.) or output (e.g., a display, a speaker, etc.). In some embodiments, the controller 120 may include an interface to connect to another compute device, such as USB, Ethernet, RS-232, etc.

In some embodiments, some of the components of the controller 120 may be directly connected to the motors 110, 114 or actuators 608 (e.g., by wires 122 or traces on a circuit board) and other components may be wirelessly connected. For example, circuitry for driving the motors 110, 114 or actuators 608 may be secured to the plate 104, and circuitry for determining how and when to drive the motors 110, 114 or actuators 608 may be physically separate or remote from the local circuitry of the controller 120. Such separate or remote circuitry may be connected to the local circuitry, such as by a network or direct wireless connection. The separate or remote circuitry of the controller 120 may be embodied as, e.g., a mobile compute device carried by the user, a server, a cloud-based device, and/or the like.

Referring now to FIG. 9, in an illustrative embodiment, the controller 120 establishes an environment 900 during operation. The illustrative environment 900 includes a parameter determiner 902, a weight movement controller 904, a movement log 906, and a communication controller 912. The various modules of the environment 900 may be embodied as hardware, software, firmware, or a combination thereof. For example, the various modules, logic, and other components of the environment 900 may form a portion of, or otherwise be established by, the processor 802, the memory 804, the data storage 808, or other hardware components of the controller 120. As such, in some embodiments, one or more of the modules of the environment 900 may be embodied as circuitry or collection of electrical devices (e.g., parameter determiner circuitry 902, weight movement controller circuitry 904, movement log circuitry 906, etc.). It should be appreciated that, in such embodiments, one or more of the circuits (e.g., the parameter determiner circuitry 902, the weight movement controller circuitry 904, the movement log circuitry 906, etc.) may form a portion of one or more of the processor 802, the memory 804, the I/O subsystem 806, the data storage 808, and/or other components of the controller 120. For example, in some embodiments, some or all of the modules may be embodied as the processor 802 as well as the memory 804 and/or data storage 808 storing instructions to be executed by the processor 802. Additionally, in some embodiments, one or more of the illustrative modules may form a portion of another module and/or one or more of the illustrative modules may be independent of one another. Further, in some embodiments, one or more of the modules of the environment 900 may be embodied as virtualized hardware components or emulated architecture, which may be established and maintained by the processor 802 or other components of the controller 120. It should be appreciated that some of the functionality of one or more of the modules of the environment 900 may require a hardware implementation, in which case embodiments of modules that implement such functionality will be embodied at least partially as hardware.

The parameter determiner 902 is configured to determine parameters to control operation of the device 102, 600. For example, the parameter determiner 902 may determine an amplitude of movement of the weighted component, a frequency of movement of the weighted component, an amount of time to wait between movements, etc. The parameter determiner 902 may determine parameters based on biometrics of the user (e.g., height and weight), a parameter indicating how much assistance a particular user requires, etc. How much assistance a user requires may be provided as an input or may be determined during operation of the device 102, 600 (e.g., based on feedback from the motion sensors 814).

The weight movement controller 904 is configured to control movement of the weighted components. The weight movement controller 904 may determine an amplitude, velocity, acceleration, etc., of a particular movement. For example, the weight movement controller 904 may determine that the weighted component should move from −30° to +20° in 0.6 seconds. In order to keep the user 100 engaged in actively compensating for the forces applied by the device 102, 600, in the illustrative embodiment, the weight movement controller 904 moves the weighted components in a random or otherwise irregular fashion. For example, the weight movement controller 904 may randomly determine an orientation and/or position of the weighted component between a maximum and minimum. The weight movement controller 904 may randomly select the orientation and/or position from a uniform distribution or any other suitable distribution, such as a Gaussian, ramp, etc. Similarly, the weight movement controller 904 may randomly determine a velocity and/or acceleration of the weighted component during the movement. The weight movement controller 904 may also randomly determine a pause between movements, if any. The weight movement controller 904 may use any suitable source to generate random or irregular numbers, such as a random number generator, a pseudo-random number generator, a fixed and irregular sequence, etc. It should be appreciated that, in the illustrative embodiment, the movement needs to be irregular enough that the user 100 does not readily adapt to or predict the movement, but the variation in movement does not need to be truly random or particularly complex. In other embodiments, the weight movement controller 904 may move the weighted component in a regular or predictable manner. In embodiments with more than one degree of freedom, the weight movement controller 904 may move both degrees of freedom simultaneously, sequentially, or randomly select one or more degrees of freedom to move.

In some embodiments, the weight movement controller 904 can adjust movements of the weight based on the user's movements. For example, if the user is sensed to have a shuffling, stooped-over gait, the weight movement controller 904 may increase the amplitude of the movements. If the user is sensed to have a typical walking gait or stride but is off-balance more than a desired or threshold amount, the weight movement controller 904 may decrease the amplitude of the movements. In some embodiments, the weight movement controller 904 may be trained using a computer-learning-based algorithm to determine what movements of the weighted component to make, optionally with the movements of the user as an input.

In the illustrative embodiment, the weight movement controller 904 can be activated or deactivated by, e.g., the user 100 pressing a button or switch. In some embodiments, the weight movement controller 904 may be activated or deactivated automatically. For example, the weight movement controller 904 may sense that the user 100 has stood up or started walking and may, in response, activate. The weight movement controller 904 may sense that the user 100 has sat down or stopped walking and may, in response, deactivate. In some embodiments, the weight movement controller 904 may activate in response to a determination that the user has a stooped-over posture and/or a shuffling gait.

The movement log 906 is configured to store movement data, such as on the data storage 808. The movement log 908 includes a weight movement log 908 and a user movement log 910. The weight movement log 908 is configured to store movement data of the weighted component. The user movement log 910 is configured to store movement data of the user as sensed by the motion sensor 814.

The communication controller 912 is configured to send and receive data. In some embodiments, part of the controller 120 may be remote from the user, and the communication controller 912 may send and/or receive data to a remote component that is physically separate from other parts of the controller or from the user.

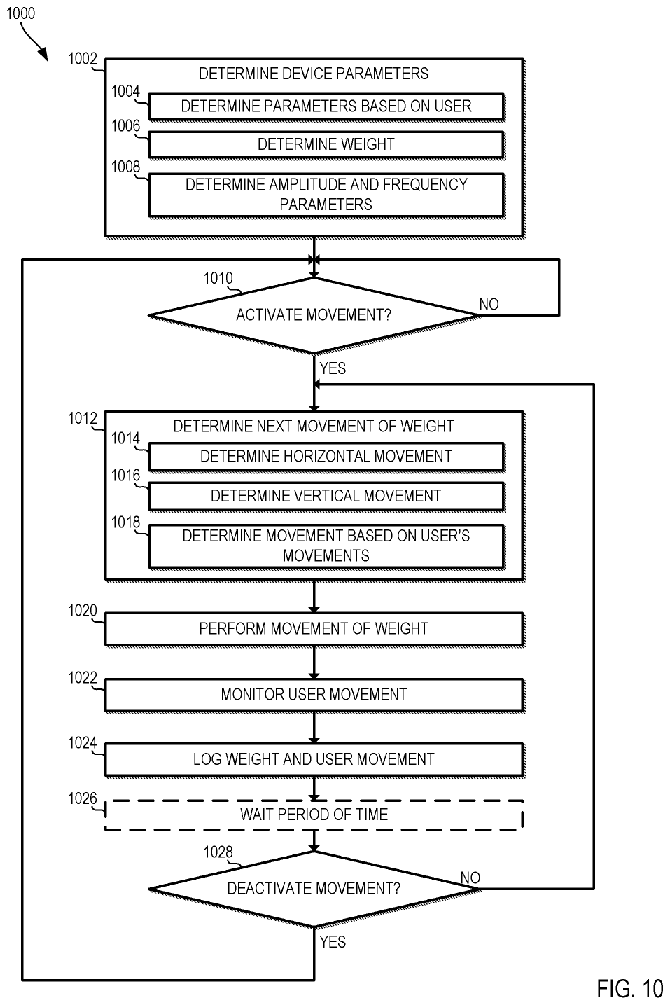

Referring now to FIG. 10, in use, the controller 120 may execute a method 1000 for operating the device 102, 600. The method 1000 begins in block 1002, in which the controller 120 determines parameters to control operation of the device 102, 600. In block 1004, the controller 120 may determine parameters based on biometrics of the user (e.g., height and weight), a parameter indicating how much assistance a particular user requires, etc. How much assistance a user requires may be provided as an input or may be determined during operation of the device 102, 600 (e.g., based on feedback from the motion sensors 814). In block 1006, the controller 120 determines a weight that should be used. The weight may be configurable by a user (e.g., by physically inserting a weight of a particular mass), or the controller 120 may select one or more weights out of a set of weights to move, allowing the controller 120 to control the electronically or automatically adjust the weight. In block 1008, the controller may determine parameters such as an amplitude of movement of the weighted component, a frequency of movement of the weighted component, an amount of time to wait between movements, etc.

In block 1010, if the controller 120 is to activate movement of the device, the method 1000 proceeds to block 1012. If the controller 120 is not to activate movement of the device, the method 1000 loops back to block 1010 to again check whether to activate movement of the device. The controller 120 may determine whether to activate movement of the device in any suitable manner, such as by the user 100 pressing a button or switch. In some embodiments, the controller 120 may activate automatically. For example, the controller 120 may sense that the user 100 has stood up or started walking and may, in response, activate. In some embodiments, the controller 120 may activate in response to a determination that the user has a stooped-over posture and/or a shuffling gait.

In block 1012, the controller 120 determines the next movement of a weighted component. The controller 120 may determine an amplitude, velocity, acceleration, etc., of a particular movement. For example, the controller 120 may determine that the weighted component should move from −30° to +20° in 0.6 seconds. In the illustrative embodiment, the controller 120 moves the weighted components in a random or otherwise irregular fashion. For example, the controller 120 may randomly determine an orientation and/or position of the weighted component between a maximum and minimum. The controller 120 may randomly select the orientation and/or position from a uniform distribution or any other suitable distribution, such as a Gaussian, ramp, etc. Similarly, the controller 120 may randomly determine a velocity and/or acceleration of the weighted component during the movement. The controller 120 may also randomly determine a pause between movements, if any. The weight movement controller 904 may use any suitable source to generate random or irregular numbers, such as a random number generator, a pseudo-random number generator, a fixed and irregular sequence, etc.

In block 1014, the controller 120 may determine a horizontal movement (i.e., translating or rotating a weighted component in a horizontal plane). In block 1016, the controller may determine a vertical movement (i.e., translating or rotating a weighted component in a vertical plane).

In block 1018, the controller 120 may determine a movement based on the user's movements. For example, if the user is sensed to have a shuffling, stooped-over gait, the controller 120 may increase the amplitude of the movements. If the user is sensed to have a typical walking gait or stride but is off-balance more than a desired or threshold amount, the controller 120 may decrease the amplitude of the movements.

In block 1020, the controller 120 performs the movement of the weighted component. In block 1022, the controller 120 monitors the movement of the weighted component. In block 1024, the controller 120 logs the movement of the user and the weighted component.

In block 1028, if the controller 120 is to deactivate movement, the method 1000 loops back to block 1010 to determine whether the controller 120 should activate movement. If the controller 120 is not to deactivate movement, the method 1000 loops back to block 1012 to determine the next movement of the weight. The controller 120 may determine that it should deactivate based on, e.g., the user 100 pressing a button or switch. In some embodiments, the controller 120 may automatically deactivate if it senses that the user has sat down or stopped walking.

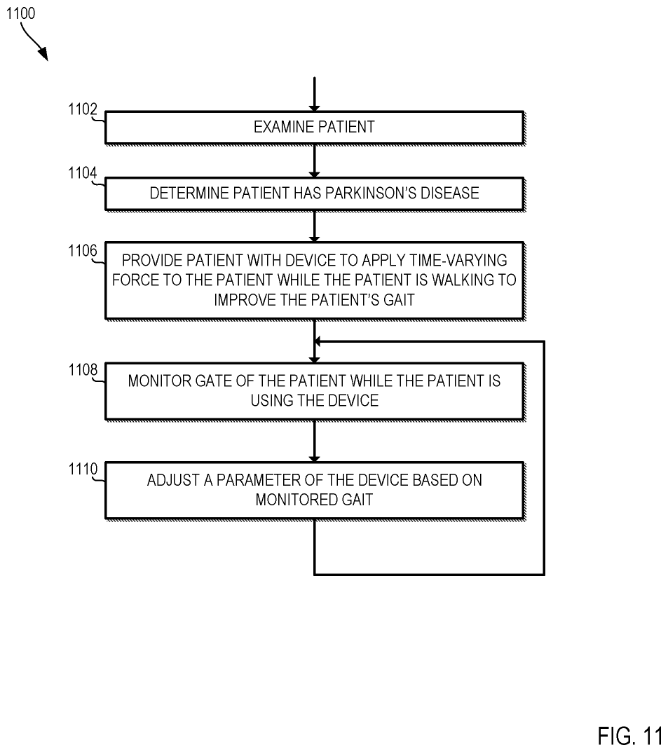

Referring now to FIG. 11, in one embodiment, a caregiver may treat a patient with use of the device 102, 600. The method 1100 begins in block 1102, in which a caregiver examines a patient. The caregiver may be, e.g., a doctor, a nurse, a pharmacist, or the caregiver may be a combination of two or more of the above. The caregiver may perform any suitable set of tests on the patient. In block 1104, the caregiver determines that the patient has Parkinson's disease based on the examination of the patient.

In block 1106, the caregiver provides the patent with a device (such as the device 102, 600) to apply time-varying force to the patient while the patient is walking to improve the patient's gait. The device may operate in accordance with various embodiments described above.

In block 1108, the caregiver monitors the gait of the patient while the patient is using the device. In block 1110, the caregiver may adjust a parameter of the device based on the monitored gait. The caregiver may make several adjustments before determining a suitable set of parameters for the patient.

### EXAMPLES

Illustrative examples of the technologies disclosed herein are provided below. An embodiment of the technologies may include any one or more, and any combination of, the examples described below.

Example 1 includes a device comprising one or more straps that enable a user to wear the device; a weighted component; and a controller to move the weighted component to apply an irregular time-varying force to the user.

Example 2 includes the subject matter of Example 1, and wherein the weighted component has a mass between 50 and 2,000 grams.

Example 3 includes the subject matter of any of Examples 1 and 2, and wherein the one or more straps enable the user the wear the device as a backpack.

Example 4 includes the subject matter of any of Examples 1-3, and wherein to move the weighted component to apply the irregular time-varying force to the user comprises to determine a next movement of the weight with use of a random number generator; and perform the next movement of the weight based on the random number generator.

Example 5 includes the subject matter of any of Examples 1-4, and wherein the controller is to move the weighted component such that a force applied by the device to the user changes by at least one Newton in less than one second.

Example 6 includes the subject matter of any of Examples 1-5, and wherein the controller, when activated, is to move the weighted component at least five centimeters at least once every five seconds.

Example 7 includes the subject matter of any of Examples 1-6, and wherein, when the user has Parkinson's disease, the controller is to move the weighted component to apply the irregular time-varying force to the user that improves a gait of the user.

Example 8 includes the subject matter of any of Examples 1-7, and further including one or more motion sensors indicative of movement of the user, wherein the controller is to receive data from the one or more motion sensors, wherein the data is indicative of movement of the user; and control movement of the weighted component based on the data indicative of movement of the user.

Example 9 includes the subject matter of any of Examples 1-8, and further including one or more motion sensors indicative of movement of the user, wherein the controller is to receive data from the one or more motion sensors, wherein the data is indicative of movement of the user; and store the data.

Example 10 includes the subject matter of any of Examples 1-9, and wherein the weighted component is mounted on a two-axis arm, the device further comprising a first motor to rotate the weighted component about one axis of the two-axis arm; and a second motor to rotate the weighted component about a second axis of the two-axis arm.

Example 11 includes the subject matter of any of Examples 1-10, and wherein the weighted component is connected to a linear actuator, wherein to move the weighted component comprises to move the weighted component by translating the weighted component with use of the linear actuator.

Example 12 includes the subject matter of any of Examples 1-11, and wherein the controller is to pause a random amount of time between movements of the weighted component.

Example 13 includes the subject matter of any of Examples 1-12, and further including a mount connected to the weighted component, wherein the user can adjust the mount and the weighted component towards a more superior position or towards a more inferior position.

Example 14 includes a method of treating Parkinson's disease, the method comprising determining that a patient has Parkinson's disease; and providing, in response to a determination that the patient has Parkinson's disease, the patient with a device, wherein the device is to apply an irregular time-varying force to the patient while the patient is walking.

Example 15 includes the subject matter of Example 14, and further including monitoring a gait of the patient while the patient is using the device; and adjusting a parameter of the device based on the monitoring of the gait of the patient.

Example 16 includes the subject matter of any of Examples 14 and 15, and wherein the device comprises one or more straps that enable a user to wear the device; a weighted component; and a controller to move the weighted component to apply the irregular time-varying force to the user.

Example 17 includes the subject matter of any of Examples 14-16, and wherein the weighted component has a mass between 50 and 2,000 grams.

Example 18 includes the subject matter of any of Examples 14-17, and wherein the one or more straps enable the user the wear the device as a backpack.

Example 19 includes the subject matter of any of Examples 14-18, and wherein to move the weighted component to apply the irregular time-varying force to the user comprises to determine a next movement of the weight with use of a random number generator; and perform the next movement of the weight based on the random number generator.

Example 20 includes the subject matter of any of Examples 14-19, and wherein the controller is to move the weighted component such that a force applied by the device to the user changes by at least one Newton in less than one second.

Example 21 includes the subject matter of any of Examples 14-20, and wherein the controller, when activated, is to move the weighted component at least five centimeters at least once every five seconds.

Example 22 includes the subject matter of any of Examples 14-21, and wherein the device further comprises one or more motion sensors indicative of movement of the user, wherein the controller is to receive data from the one or more motion sensors, wherein the data is indicative of movement of the user; and control movement of the weighted component based on the data indicative of movement of the user.

Example 23 includes the subject matter of any of Examples 14-22, and wherein the device further comprises one or more motion sensors indicative of movement of the user, wherein the controller is to receive data from the one or more motion sensors, wherein the data is indicative of movement of the user; and store the data.

Example 24 includes the subject matter of any of Examples 14-23, and wherein the weighted component is mounted on a two-axis arm, the device further comprising a first motor to rotate the weighted component about one axis of the two-axis arm; and a second motor to rotate the weighted component about a second axis of the two-axis arm.

Example 25 includes the subject matter of any of Examples 14-24, and wherein the weighted component is connected to a linear actuator, wherein to move the weighted component comprises to move the weighted component by translating the weighted component with use of the linear actuator.

Example 26 includes the subject matter of any of Examples 14-25, and wherein the controller is to pause a random amount of time between movements of the weighted component.

Example 27 includes the subject matter of any of Examples 14-26, and wherein the device further comprises a mount connected to the weighted component, wherein the user can adjust the mount and the weighted component towards a more superior position or towards a more inferior position.

Example 28 includes a method comprising improving a gait of a person with Parkinson's disease by using a device to apply an irregular time-varying force to the person while the person is walking.

Example 29 includes the subject matter of Example 28, and wherein the device comprises one or more straps that enable the person to wear the device; a weighted component; and a controller to move the weighted component to apply the irregular time-varying force to the person.

Example 30 includes the subject matter of any of Examples 28 and 29, and wherein the weighted component has a mass between 50 and 2,000 grams.

Example 31 includes the subject matter of any of Examples 28-30, and wherein the one or more straps enable the person the wear the device as a backpack.

Example 32 includes the subject matter of any of Examples 28-31, and wherein to move the weighted component to apply the irregular time-varying force to the person comprises to determine a next movement of the weight with use of a random number generator; and perform the next movement of the weight based on the random number generator.

Example 33 includes the subject matter of any of Examples 28-32, and wherein the controller is to move the weighted component such that a force applied by the device to the person changes by at least one Newton in less than one second.

Example 34 includes the subject matter of any of Examples 28-33, and wherein the controller, when activated, is to move the weighted component at least five centimeters at least once every five seconds.

Example 35 includes the subject matter of any of Examples 28-34, and wherein the device further comprises one or more motion sensors indicative of movement of the person, wherein the controller is to receive data from the one or more motion sensors, wherein the data is indicative of movement of the person; and control movement of the weighted component based on the data indicative of movement of the person.

Example 36 includes the subject matter of any of Examples 28-35, and wherein the device further comprises one or more motion sensors indicative of movement of the person, wherein the controller is to receive data from the one or more motion sensors, wherein the data is indicative of movement of the person; and store the data.

Example 37 includes the subject matter of any of Examples 28-36, and wherein the weighted component is mounted on a two-axis arm, the device further comprising a first motor to rotate the weighted component about one axis of the two-axis arm; and a second motor to rotate the weighted component about a second axis of the two-axis arm.

Example 38 includes the subject matter of any of Examples 28-37, and wherein the weighted component is connected to a linear actuator, wherein to move the weighted component comprises to move the weighted component by translating the weighted component with use of the linear actuator.

Example 39 includes the subject matter of any of Examples 28-38, and wherein the controller is to pause a random amount of time between movements of the weighted component.

Example 40 includes the subject matter of any of Examples 28-39, and wherein the device further comprises a mount connected to the weighted component, wherein the person can adjust the mount and the weighted component towards a more superior position or towards a more inferior position.

Example 41 includes a device comprising one or more straps that enable a user to wear the device; a weighted component; and means for moving the weighted component to apply an irregular time-varying force.

Example 42 includes the subject matter of Example 41, and wherein the weighted component has a mass between 50 and 2,000 grams.

Example 43 includes the subject matter of any of Examples 41 and 42, and wherein the one or more straps enable the user the wear the device as a backpack.

Example 44 includes the subject matter of any of Examples 41-43, and wherein the means for moving the weighted component to apply the irregular time-varying force to the user comprises means for determining a next movement of the weight with use of a random number generator; and means for performing the next movement of the weight based on the random number generator.

Example 45 includes the subject matter of any of Examples 41-44, and further including means for moving the weighted component such that a force applied by the device to the user changes by at least one Newton in less than one second.

Example 46 includes the subject matter of any of Examples 41-45, and further including means for moving the weighted component at least five centimeters at least once every five seconds.

Example 47 includes the subject matter of any of Examples 41-46, and further including means for moving the weighted component to apply the irregular time-varying force to the user that, when the user has Parkinson's disease, improves a gait of the user.

Example 48 includes the subject matter of any of Examples 41-47, and further including one or more motion sensors indicative of movement of the user; means for receiving data from the one or more motion sensors, wherein the data is indicative of movement of the user; and means for controlling movement of the weighted component based on the data indicative of movement of the user.

Example 49 includes the subject matter of any of Examples 41-48, and further including one or more motion sensors indicative of movement of the user; means for receive data from the one or more motion sensors, wherein the data is indicative of movement of the user; and means for storing the data.

Example 50 includes the subject matter of any of Examples 41-49, and wherein the weighted component is mounted on a two-axis arm, the device further comprising a first motor to rotate the weighted component about one axis of the two-axis arm; and a second motor to rotate the weighted component about a second axis of the two-axis arm.

Example 51 includes the subject matter of any of Examples 41-50, and wherein the weighted component is connected to a linear actuator, wherein the means for moving the weighted component comprises means for moving the weighted component by translating the weighted component with use of the linear actuator.

Example 52 includes the subject matter of any of Examples 41-51, and wherein the means for moving the weighted component are to pause a random amount of time between movements of the weighted component.

Example 53 includes the subject matter of any of Examples 41-52, and further including a mount connected to the weighted component, wherein the user can adjust the mount and the weighted component towards a more superior position or towards a more inferior position.

1. A device comprising:
one or more straps that enable a user to wear the device as a backpack;
a weighted component; and
a controller to:
determine an initial amplitude parameter for the device;
move the weighted component to apply a first irregular time-varying force to the user at least partially based on the initial amplitude parameter;
monitor a gait of the user for one or more steps while the user is using the device with the initial amplitude parameter;
analyze the gait of the user for the one or more steps;
update the initial amplitude parameter based on the analysis of the gait of the user for the one or more steps; and
move the weighted component to apply a second irregular time-varying force to the user for an additional one or more steps at least partially based on the updated amplitude parameter, wherein the second irregular time-varying force is to shift the balance of the user enough to complicate the task of walking.

2. The device of claim 1, wherein the weighted component has a mass between 50 and 2,000 grams.

3. (canceled)

4. The device of claim 1, wherein to move the weighted component to apply the second irregular time-varying force to the user comprises to:
determine a next movement of the weighted component with use of a random number generator; and
perform the next movement of the weighted component based on the random number generator.

5. The device of claim 1, wherein the controller is to move the weighted component such that a force applied by the device to the user changes by at least one Newton in less than one second.

6. The device of claim 1, wherein the controller, when activated, is to move the weighted component at least five centimeters at least once every five seconds.

7. The device of claim 1, wherein, when the user has Parkinson's disease, the controller is configured to move the weighted component to apply the second irregular time-varying force to the user improve the gait of the user while the user is using the device by shifting the balance of the user enough to complicate the task of walking.

8. The device of claim 1, further comprising one or more motion sensors indicative of movement of the user, wherein the controller is to:
receive data from the one or more motion sensors, wherein the data is indicative of movement of the user; and
control movement of the weighted component based on the data indicative of movement of the user.

9. The device of claim 1, further comprising one or more motion sensors indicative of movement of the user, wherein the controller is to:
receive data from the one or more motion sensors, wherein the data is indicative of movement of the user; and
store the data.

10. The device of claim 1, wherein the weighted component is mounted on a two-axis arm, the device further comprising:
a first motor to rotate the weighted component about one axis of the two-axis arm; and
a second motor to rotate the weighted component about a second axis of the two-axis arm.

11. The device of claim 1, wherein the weighted component is connected to a linear actuator, wherein to move the weighted component comprises to move the weighted component by translating the weighted component with use of the linear actuator.

12. The device of claim 1, wherein the controller is to:
generate a random or pseudorandom value of time of at least 1/10 of a second; and
pause an amount of time equal to the random or pseudorandom value of time between movements of the weighted component.

13. The device of claim 1, further comprising a mount connected to the weighted component, wherein the user can adjust the mount and the weighted component relative to the one or more straps towards a more superior position or towards a more inferior position.

14. A method of treating Parkinson's disease, the method comprising:
determining that a patient has Parkinson's disease; and
providing, in response to a determination that the patient has Parkinson's disease, the patient with a device, wherein the device is to apply an irregular time-varying force to the patient while the patient is walking in order to complicate the task of walking, thereby improving a current gait of the patient.

15. The method of claim 14, further comprising:
determining an initial amplitude parameter for the device;
applying the irregular time-varying force at least partially based on the initial amplitude parameter;
monitoring a gait of the patient for one or more steps while the patient is using the device with the initial amplitude parameter;
updating the initial amplitude parameter based on the monitored gait of the patient for one or more steps; and
applying the irregular time-varying force over an additional one or more steps at least partially based on the updated amplitude parameter, wherein the irregular time-varying force requires the patient to actively compensate for the irregular time-varying force in order to stay balanced.

16. The method of claim 14, wherein the device comprises:
one or more straps that enable a user to wear the device;
a weighted component; and
a controller to move the weighted component to apply the irregular time-varying force to the user.

17. A method comprising:
improving a current gait of a person with Parkinson's disease by using a device to apply an irregular time-varying force to a torso of the person while the person is walking, wherein the irregular time-varying force is applied to require the person to actively compensate for the irregular time-varying force in order to stay balanced.

18. The method of claim 17, wherein the device comprises:
one or more straps that enable the person to wear the device;
a weighted component; and
a controller to move the weighted component to apply the irregular time-varying force to the person.

19. A device comprising:
one or more straps that enable a user to wear the device;
a weighted component;
means for determining an initial amplitude parameter for the device;
means for moving the weighted component to apply a first irregular time-varying force at least partially based on the initial amplitude parameter;
means for monitoring a gait of the user for one or more steps while the user is using the device with the initial amplitude parameter;
means for analyzing the gait of the user for the one or more steps;
means for updating the initial amplitude parameter based on the analysis of the gait of the user for the one or more steps; and
means for moving the weighted component to apply a second irregular time-varying force to the user at least partially based on the updated amplitude parameter.

20. The device of claim 19, wherein the means for moving the weighted component to apply the second irregular time-varying force to the user comprises:
means for determining a next movement of the weight with use of a random number generator; and
means for performing the next movement of the weight based on the random number generator.

21. (canceled)

22. The method of claim 17, wherein improving the gait of the person with Parkinson's disease by using the device comprises improving the gait of the person with Parkinson's disease by using the device to shift a center of gravity of the person.

23. The method of claim 14, wherein an active compensation by the patient for the irregular time-varying force during the current gait allows the patient with Parkinson's disease to walk with an improved gait during the current gait.

24. The method of claim 17, wherein an active compensation by the person for the irregular time-varying force during the current gait allows the person with Parkinson's disease to walk with an improved gait during the current gait.
